(19) United States
(12) Patent Application Publication
(10) Pub. No.: US 2006/0068835 A1
(43) Pub. Date: Mar. 30, 2006

(54) Background sound mixer for mobile audio platform applications and methods thereof

(75) Inventor: Adam Che-Ya Chang, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Macronix International Co., Ltd.

(21) Appl. No.: 11/227,621

(22) Filed: Sep. 15, 2005

Related U.S. Application Data
(60) Provisional application No. 60/614,058, filed on Sep. 30, 2004.

(51) Int. Cl. H04M 1/00

(52) U.S. Cl. 455/550.1; 455/412.1

(57) ABSTRACT

A cellular phone including a host processor, a host interface coupled to the host processor, a sound mixer coupled to the host processor and provides an output signal to the host processor through the host interface, and an audio analog-to-digital converter (ADC) coupled to the sound mixer to provide an input signal, wherein the sound mixer receives the input signal and a pre-recorded signal, and wherein the sound mixer combines the input signal and the pre-recorded signal to produce the output signal.

### CROSS-REFERENCE TO RELATED APPLICATIONS

This application claims the benefit of U.S. Provisional Application No. 60/614,058, filed Sep. 30, 2004, which is herein incorporated by reference in its entirety.

### BACKGROUND OF THE INVENTION

1. Field of the Invention

The present invention relates generally to a mobile telephone and, more particularly, to a system architecture for providing output data combining incoming audio or speech data with pre-recorded data in a mobile communications setting.

2. Background Art

Cellular, or mobile, phones today are capable of performing a wide variety of tasks due to improvements in the semiconductor technology. Cellular phones, for example, not only can be used to place calls, but also may be used to access the Internet, send and receive email and text messages, and act as a personal digital assistant (or PDA). More fundamentally, cellular phones can be used to call almost anywhere around the world.

However, due to the increasing popularity, manufacturers are adding functionalities to a cellular phone. Specifically with regard to audio/speech capabilities, conventional cellular phones require different system architecture setups to perform different functionalities due to different requirements for signal processing.

### BRIEF SUMMARY OF THE INVENTION

In accordance with the present invention, there is provided a mobile communications device that includes a host processor and a sound mixer coupled to the host processor. The sound mixer receives an input signal and a pre-recorded signal, includes a firmware for multi-platform applications, and combines the input signal and the pre-recorded signal to produce an output signal.

Also in accordance with the present invention, there is provided a cellular phone that includes a host processor, a host interface coupled to the host processor, a sound mixer coupled to the host processor and provides an output signal to the host processor through the host interface, and an audio analog-to-digital converter (ADC) coupled to the sound mixer to provide an input signal, wherein the sound mixer receives the input signal and a pre-recorded signal, and wherein the sound mixer combines the input signal and the pre-recorded signal to produce the output signal.

Further in accordance with the present invention, there is provided a cellular phone that includes a sound mixer for receiving an incoming analog audio signal and an audio digital-to-analog converter (DAC) coupled to the sound mixer to provide a analog pre-recorded audio signal, wherein the sound mixer combines the incoming analog audio signal and the pre-recorded audio signal to produce an analog output signal.

Additionally in accordance with the present invention, there is provided a method of signal processing in a mobile communications device that includes providing a host processor, providing a sound mixer coupled to the host processor, receiving an input signal, receiving a pre-recorded signal, and combining by the sound mixer the input signal and the pre-recorded signal to produce an output signal.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a block diagram of a cellular system architecture consistent with one embodiment of the present invention;

FIG. 2 is an exemplary block diagram of the mobile audio platform device;

FIG. 3 is a block diagram consistent with one embodiment of the mobile audio platform device;

FIG. 4 is a flow diagram of a method consistent with one embodiment of the present invention;

FIG. 5 is a block diagram consistent with one embodiment of the present invention; and

FIG. 6 is a block diagram consistent with another embodiment of the present invention.

### DETAILED DESCRIPTION OF THE INVENTION

In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

Embodiments of the present invention relate to apparatuses and methods for a mobile audio platform (“MAP”) architecture operable between a baseband processor and either an output device or an input device. The architecture and method of MAP of the present invention may be preferably implemented in a mobile communications device that either receives or outputs analog signals, such as a cellular telephone or any mobile communications device with an integrated cellular phone. Consistent with the present invention, a single MAP architecture provides multi-platform applications that provide enhanced audio/speech signal processing.

Embodiments of systems and methods related to a mobile audio MAP architecture are described in this detailed description of the invention, which includes the accompanying drawings. In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

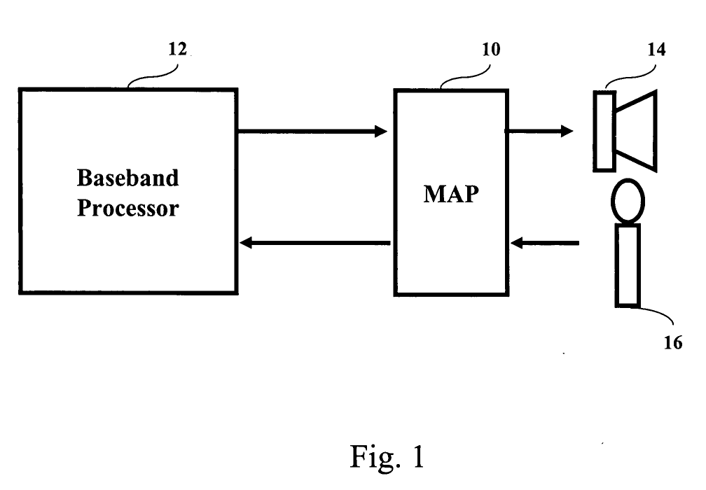

FIG. 1 is a block diagram of the general architecture consistent with one embodiment of the MAP of the present invention. Referring to FIG. 1, a MAP 10 is coupled to a baseband processor 12, an output device 14, and an input device 16. Examples of output device 14 include speakers, headphones, and analog baseband devices. Examples of input device 16 include microphones, FM receivers, and baseband devices capable of producing an analog signal. In the cellular communications context, baseband processor 12 may be implemented in a baseband chipset with an ARM® RISC processor and is also referred to herein as a host processor. A host processor is primarily responsible for protocol processing and user interface. The functions of a host processor and MAP 10 include the ability to access system memories, such as flash memories, random access memories (RAMs), read-only memories (ROMs), and static random access memories (SRAMs), control peripheral components such as LCD and other visual displays and indicators, and process signals received from a peripheral component such as a keypad. MAP 10 may also be referred to herein as a target processor. A telecommunications device of the present invention may incorporate a plurality of MAPs to afford the device different functionalities, coupled with different firmware, to be provided by the MAPs.

In its most rudimentary form, MAP 10 is a co-processor directed to audio or speech applications and may be disposed between a baseband chipset and electro-acoustic components in a telecommunications device. Through firmware, a MAP is able to transform a single-tone into a melody. In one embodiment, MAP 10 is a digital signal processor (DSP) capable of physical layer processing, and may include speech or audio coder/decoders (CODECs). MAP 10 may be implemented as a separate integrated circuit from baseband processor 12 or integrated with baseband processor 12. The functions of MAP 10 are controlled by different algorithms, or firmware. The firmware is adapted for multi-platform applications, such as speech compression and decompression, audio decoding, and signal processing. Such algorithms and firmware can be implemented by MAP 10 to convert one type of tone so that a certain melody can be outputted. In one embodiment, the algorithms or firmware is stored in system memories described above.

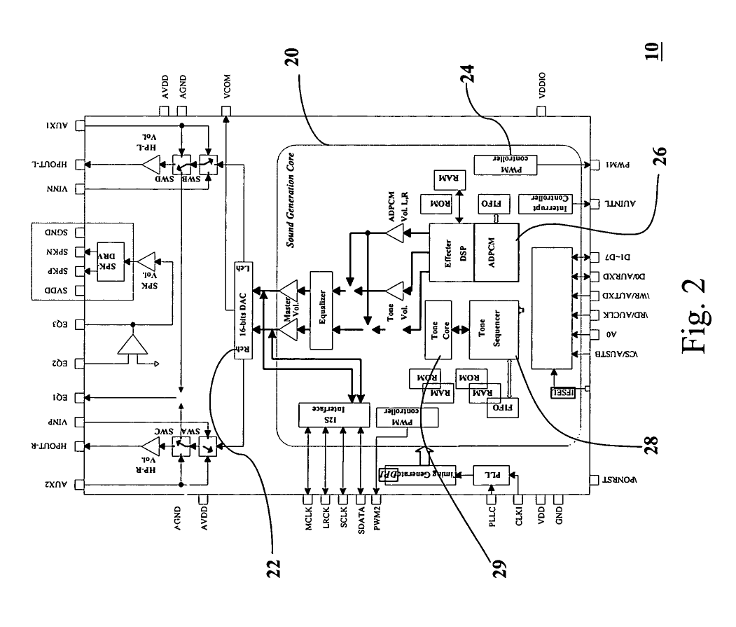

FIG. 2 is a block diagram of an embodiment of MAP 10 of FIG. 1. Referring to FIG. 2, MAP 10 includes a 16-bit DAC 22 and a sound generation core 20. Sound generation core 20 includes a parametric equalizer that is fully firmware controlled capable of tuning for speaker characteristics in system implementation. Sound generation core 20 also includes a pulse width modulation (PWM) controller 24 for vibration and light emitting diode (LED) control. PWM controller 24 may be controlled by incoming contents and/or threshold settings. For example, vibration control settings may be downloaded into the firmware for MAP 10 that controls the type of vibration provided by PWM controller 24. MAP 10 also includes a plurality of interfaces for receiving input signals from input devices and providing output signals to output devices and/or other components.

Sound generation core 20 additionally includes an Adaptive Differential Pulse Code Modulation (ADPCM) CODEC 26 for digital speech compression. In addition to processing speech signals, ADPCM CODEC 26 is also capable of processing music and sound effects. Sound generation core 20 further includes a hardware sequencer in the form of a tone sequencer 28 coupled to a tone core 29.

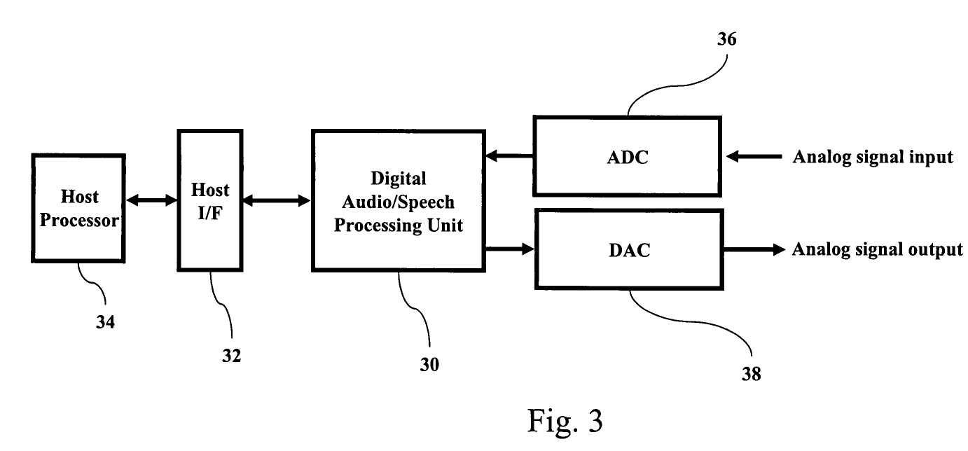

FIG. 3 is a more detailed block diagram of FIG. 1. Referring to FIG. 3, a digital audio/speech processing unit 30 is one embodiment of the MAP of the present invention. Digital audio/speech processing unit 30 is coupled to a host interface 32, which in turn is coupled to a host processor 34. Host interface 32 may be integrated with host processor 34. Digital audio/speech processing unit 30 is also coupled to an ADC (analog-to-digital converter) 36 and a DAC (digital-to-analog converter) 38. In one embodiment, ADC 36 and DAC 38 are integrated with digital audio/speech processing unit 30. ADC 36 receives analog signals and outputs digital signals whereas DAC 38 receives digital signals and outputs analog signals.

In operation, ADC 36 receives an input analog signal and converts it to a digital signal. The digital signal is provided to audio/speech processing unit 30, which manipulates the digital signal as specified by a particular MAP operation. Audio/speech processing unit 30 then either transfers the processed digital data to host processor 34 via host I/F 32, or converts the processed digital data to analog signal via DAC 38 and delivers it to an analog input port of other processors, or output devices such as speakers and headphones.

More generally, programs (or firmware) of the MAP processor is stored in an on-board, or system, memory controlled by the host processor. When needed, the programs may be downloaded to a program memory of the MAP. The size of the program memory may be of different sizes. In one embodiment, system program memories may be non-volatile memories such as flash memories or EEPROMs. The architecture allows the MAP to provide a number of functions and features with limited program space. Furthermore, this architecture allows for the various programs (firmware) for the MAP to be upgraded as needed.

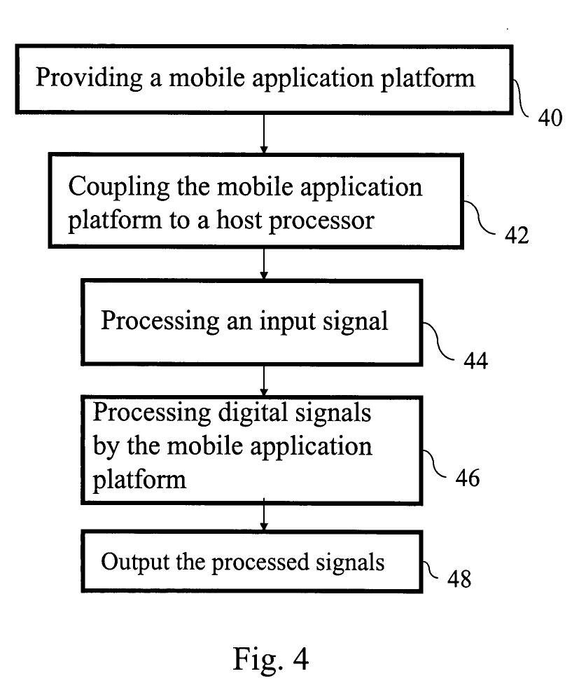

The present invention also provide as method of signal processing in a mobile communications device. FIG. 4 is a flow diagram of one method of the present invention. Referring to FIG. 4, the method includes the steps of providing a host processor and providing a host interface coupled to the host processor (not shown). The method also includes providing a mobile audio platform unit 40 and coupling the mobile audio platform unit to the host processor 42. Firmware for the mobile audio platform unit is also provided (not shown). Input signals are then processed 44, such as analog to digital conversion, and the processed signals are transferred to the host processor via the host interface. At step 46, Digital signals are provided to the mobile audio platform unit for signal processing as specified by the firmware. The processed signals are output through any one of the output devices discussed above at step 48.

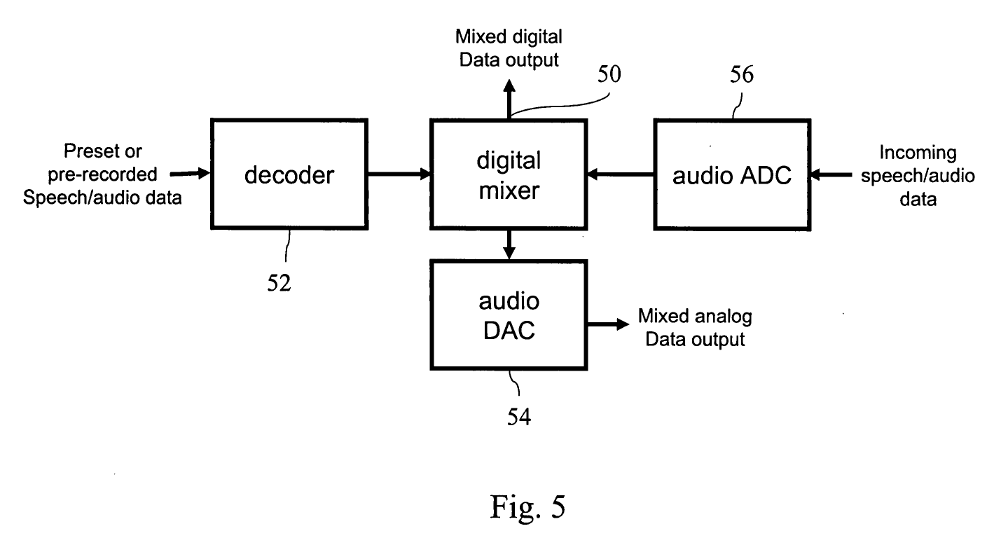

An embodiment of the present invention provides for mixing, or combining, of an incoming audio or speech signal/data with a pre-recorded or preset audio or speech signal/data by the mobile audio platform unit of the present invention. This embodiment by-passes the need for the host processor to be involved in the implementation of mixing of the signals. In this embodiment, the MAP unit of the present invention serves as a sound mixer. The sound mixer of the present invention provides an efficient methodology to mix incoming audio or speech audio or speech data with preset or pre-recorded audio or speech data because the work load on the host processor is not increased. FIG. 5 is one embodiment consistent with the present invention.

Referring to FIG. 5, an incoming speech/audio signal or data is provided to an audio ADC 56 for converting the analog signal to a digital signal. The converted signal is then provided to a digital mixer 50. Digital mixer 50 is coupled to receive outputs from a decoder 52, which receives preset or pre-recorded speech/audio data. In one embodiment, the preset or pre-recorded signals are coded and decoder 52 decodes the signals before providing them to digital mixer 50. Digital mixer 50 mixes the processed incoming signal with the preset or pre-recorded signal to produce mixed digital signals. The mixed digital signals may be provided to other components, such as the host processor (not shown), for further processing. The mixed digital signals may also be provided to an audio DAC 52, which converts the mixed digital signals to mixed analog signals. The mixed analog signals are then provided to any one of the output devices described above for broadcasting.

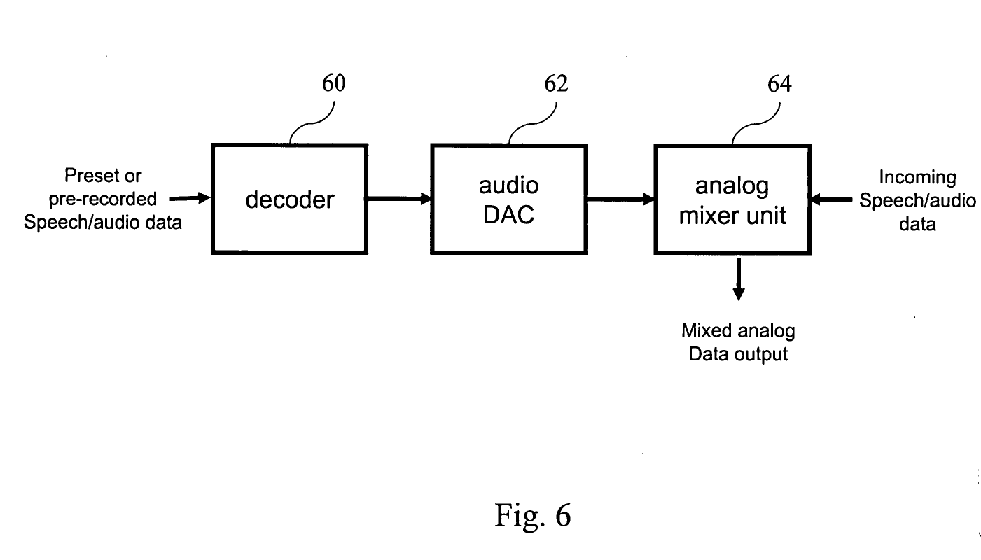

FIG. 6 is another embodiment consistent with the present invention. Referring to FIG. 6, an incoming speech/audio signal or data is provided to an analog mixer unit 64. An audio DAC 62 is coupled to receive outputs from a decoder 60, which receives preset or pre-recorded speech/audio data. In one embodiment, the preset or pre-recorded signals are coded and decoder 60 decodes the signals before providing them to audio DAC 62. Audio DAC 62 then provides the preset or pre-recorded speech/audio signals to analog mixer unit 64, which mixes the incoming signal with the preset or pre-recorded signal to produce mixed analog signals. The preset or pre-recorded data may be stored in one of the system memories. The preset or pre-recorded data may also be downloaded from an external source and stored in the system memory. The mixed analog signals are then provided to any one of the output devices described above for broadcasting.

In application, the voice of a user of the cellular phone is mixed with preset or pre-recorded sounds that serve as background sounds or noises, such as street noise, background conversations, and melodies. The combined signals are transmitted to the party on the other end of the call. The user has the option of choosing a particular background sound to mix and transmit for the call.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A mobile communications device, comprising:
a host processor; and
a sound mixer coupled to the host processor,
wherein the sound mixer receives an input signal and a pre-recorded signal,
wherein the sound mixer includes a firmware for multi-platform applications, and
wherein the sound mixer combines the input signal and the pre-recorded signal to produce an output signal.

2. The mobile communications device of claim 1, wherein the sound mixer is integrated with the host processor on a single integrated circuit.

3. The mobile communications device of claim 1, wherein the sound mixer comprises a digital sound mixer and the output signal is digital.

4. The mobile communications device of claim 3, wherein the sound mixer provides the output signal to the host processor for further processing by the host processor.

5. The mobile communications device of claim 3, further comprising an audio digital-to-analog converter (DAC) coupled to the sound mixer, wherein the sound mixer provides the output signal to the audio DAC for converting the output signal to an analog signal.

6. The mobile communications device of claim 3, further comprising a decoder coupled to the sound mixer, wherein the decoder receives and decodes a first signal to provide the pre-recorded signal.

7. The mobile communications device of claim 3, further comprising an audio analog-to-digital converter (ADC) coupled to the sound mixer to provide the input signal to the sound mixer.

8. The mobile communications device of claim 7, wherein the input signal is a digital signal converted from an incoming analog audio signal.

9. The mobile communications device of claim 1, wherein the sound mixer comprises an analog sound mixer and the output signal is analog.

10. The mobile communications device of claim 9, further comprising an audio digital-to-analog converter (DAC) coupled to the sound mixer for providing the pre-recorded signal.

11. The mobile communication device of claim 10, wherein the pre-recorded signal is analog.

12. The mobile communications device of claim 11, further comprising a decoder coupled to the audio DAC, wherein the audio DAC receives a digital pre-recorded signal and decodes the digital pre-recorded signal to provide the analog pre-recorded signal.

13. A cellular phone, comprising:
a host processor;
a host interface coupled to the host processor;
a sound mixer coupled to the host processor and provides an output signal to the host processor through the host interface; and
an audio analog-to-digital converter (ADC) coupled to the sound mixer to provide an input signal,
wherein the sound mixer receives the input signal and a pre-recorded signal, and
wherein the sound mixer combines the input signal and the pre-recorded signal to produce the output signal.

14. The cellular phone of claim 13, further comprising an audio digital-to-analog converter (DAC) coupled to the sound mixer, wherein the sound mixer provides the output signal to the audio DAC for converting the output signal to an analog signal.

15. The cellular phone of claim 13, further comprising a decoder coupled to the sound mixer, wherein the decoder receives and decodes a first signal to provide the pre-recorded signal.

16. A cellular phone, comprising:
a sound mixer for receiving an incoming analog audio signal; and
an audio digital-to-analog converter (DAC) coupled to the sound mixer to provide a analog pre-recorded audio signal,
wherein the sound mixer combines the incoming analog audio signal and the pre-recorded audio signal to produce an analog output signal.

17. The cellular phone of claim 16, further comprising a decoder coupled to the audio DAC, wherein the decoder receives and decodes a first signal to provide the pre-recorded audio signal.

18. A method of signal processing in a mobile communications device, comprising:
providing a host processor;
providing a sound mixer coupled to the host processor;
receiving an input signal;
receiving a pre-recorded signal; and
combining by the sound mixer the input signal and the pre-recorded signal to produce an output signal.

19. The method of claim 18, further comprising providing the output signal to the host processor for further processing by the host processor.

20. The method of claim 18, further comprising converting the output signal to an analog signal.

21. The method of claim 18, further comprising decoding a first signal to provide the pre-recorded signal.

22. The method of claim 18, further comprising converting the pre-recorded signal to an analog signal.
